(19) United States
(12) Patent Application Publication
(10) Pub. No.: US 2007/0237926 A1
(43) Pub. Date: Oct. 11, 2007

(54) Organic material

(76) Inventors: Barry Hall, Letchworth (GB); Karen Masters, Letchworth (GB)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/731,293

(22) Filed: Mar. 31, 2007

(30) Foreign Application Priority Data
Oct. 1, 2004 (GB) 0421823.5

(51) Int. Cl. E01F 9/04; B05D 3/00

(52) U.S. Cl. 428/143; 427/195

(57) ABSTRACT

A slip-resistant flooring has a first layer of plastics material. Bonded to an upper surface of the first layer of the plastics material is a particulate layer of one or more polymeric particles. These polymeric particles provide a slip resistant effect. Flooring material thus treated has improved cleanability and appearance.

### RELATED APPLICATION DATA

This application claims priority from GB Patent Application No. 0421823.6, filed Oct. 1, 2004, which is incorporated herein in its entirety by reference hereto.

### BACKGROUND OF THE INVENTION

1. Field of the Invention

The present invention relates to the treatment of a flooring material to improve its cleanability and appearance. In particular, it relates to a flooring material with enhanced slip resistance and especially a PVC flooring material with enhanced slip resistance treated to improve cleanability and appearance and to a method of manufacturing such a flooring material.

2. Description of the Prior Art

To provide enhanced slip resistance, a flooring material is generally manufactured having a roughened surface which can be created by embossing the surface or by the addition of particulate material to the flooring material during manufacture.

The roughened surface of the flooring material increases the risk of dirt being trapped on the surface. The dirt, depending on its nature, can be compatible with components of the flooring material resulting in absorption of the dirt into the surface giving rise to a stain. Such a stain is difficult if not impossible to remove and thus the flooring is considered to have poor cleanability.

In the past, it has been attempted to improve the stain resistance of such flooring material by applying a coating layer, for example by a powder of liquid coating process. This has been found to ameliorate the problem of absorption of the dirt into the surface of the flooring material. However, this improvement has not completely cured the problem of cleanability.

A further problem with existing flooring materials is that when a particulate material is provided to enhance the slip resistance, it is difficult to retain the particulate material in the flooring material. This prevents such slip resistant flooring materials from being used in a clean room where the amount of particulate material must be minimised e.g. in a room where electronic equipment is being manufactured.

A way to ameliorate these problems has been sought.

According to the present invention there is provided a slip-resistant plastics flooring material having a first layer of plastics material which first layer of plastics material has on its upper surface a particulate layer of one or more polymeric particles which polymeric particles provide a slip-resistant effect and are bonded to the first layer of plastics material.

It has surprisingly been found that the cleanability of the flooring material according to the invention is greatly improved compared to known flooring materials. Without wishing to be bound to a particular theory, it is believed that the improvement arises at the interface between the particulate layer and the first layer of plastics material. In known materials where mineral particles (e.g. silicon carbide or quartz) are used, it would appear that crevices are formed between the particles and the plastics layer in which they are placed. Dirt accumulates in these crevices, making the flooring material hard to clean. In the flooring material according to the invention, the number of such crevices is minimised and, preferably there are substantially no such crevices at all. This is believed to be because the particles used in the particulate layer are formed from polymeric material which is more compatible with the plastics layer than silicon carbide and bonds to the plastics layer during manufacture of the flooring material in a manner which is not possible with silicon carbide.

Furthermore it has been found that the problem of retention of particulate materials in flooring material with enhanced slip resistance has been overcome in the flooring material according to the invention. With prior art flooring material, part of the particulate material can be removed from the flooring material simply by flexing the flooring material. However this is not possible with the flooring material according to the invention. This is because of the bonding between the particulate layer and the first layer of plastics material.

The flooring material according to the invention has an upper surface which is formed by the first layer of plastics material. The particulate layer is arranged such that substantially all (preferably all) of the polymeric particles are exposed, at the upper surface of the flooring material. The particulate layer is preferably arranged such that the one or more polymeric particles penetrate the first layer of plastics material. This is in order that the one or more polymeric particles bonds to the first layer of plastics material and is embedded in the first layer such that it is hard to dislodge. Otherwise, the plastics material used to form the first layer of plastics material is preferably substantially free from the polymeric particles which provide a slip-resistant effect. This is in order to reduce costs and to ensure that the upper surface of the first layer is uniform. A further advantage of having the first layer substantially free from the polymeric particles is that it improves the appearance of the first layer. This is particularly the case where the first layer is substantially transparent or clear. The first layer of plastics material is also preferably free from a plasticizer.

The first layer of plastics material is optionally either a layer of substantially clear plastics material such that the layer is substantially translucent or substantially transparent or a layer of coloured plastics material.

The colour and/or appearance of the polymeric particles is preferably matched to the colour and/or appearance of the plastics material of the first layer. Preferably where the first layer is a layer of substantially clear plastics material, the polymeric particles are substantially clear and/or substantially translucent; where the first layer is a layer of coloured plastics material, the polymeric particles are white in colour and/or matched to the colour of the plastics material.

It has been found that by using a particulate material which is substantially transparent, substantially translucent and/or substantially white in colour, a flooring material having improved visual appearance with enhanced slip resistance is obtained.

Substantially transparent polymeric particles used in the invention preferably have a refractive index within ±0.2 of the clear coat layer.

The polymeric particles used in the invention are generally formed from a polymeric plastics material which is compatible with the plastics material used to form the first layer. Preferably the polymeric particles are formed from a material which is sufficiently hard to provide the flooring material with enhanced slip resistance. Preferably the polymeric particles are formed from a material which has a melting point which is above a highest temperature used in the process to manufacture the flooring material but not so high that the polymeric particles do not soften during that process to bond with the first layer.

The polymeric particles preferably have an angular shape such as a pyramidal shape. They are preferably jagged with a plurality of angular surfaces to maximise their enhancement of slip resistance.

Preferably the polymeric particles are formed from an optionally modified polymer such as an acrylic and/or polyacrylate (e.g. polymethylmethacrylate (PMMA) and/or polybutylmethacrylate (PBMA)), a polycarbonate, a nylon, a polyester, a polyolefin, a polyacetal, an ionomer, a polyvinylidene fluoride (PVDF), an acrylonitrile butadiene styrene (ABS), a polyaryletherketone (PEEK), and/or a polyethersulphone (PES). The polymer is preferably modified by a rubber, preferably an elastomer additive such as an acrylic rubber, a core shell impact modifier such as an acrylic impact modifier or a styrene/butadiene impact modifier. More preferably the polymeric particles are formed from an acrylic and/or polyarcrylate (e.g. polymethylmethacrylate (PMMA) and/or polybutylmethacrylate (PBMA)). Most preferably, the polymeric particles are formed from an impact modified polymethylmethacrylate polymer sheet, especially such a polymer sheet supplied by Atofina (sold as Plexiglas or Altuglas) or Rohm (sold as Plexiglas, Acrylite or Deglas). The polymeric particles are preferably formed from a suitable polymer or polymer sheet by grinding the polymer, particularly by cryogenically grinding the polymer to the desired particle size.

Since the polymeric particles are bonded to the first plastics layer, less of such particulate material is required to obtain the same long lasting slip resistant effect. In the past, more particulate material was included than was strictly necessary because of the problem with retention. Thus over a prolonged period of time it was to be expected that at least some of the particulate material would be dislodged from the surface of the flooring material. Therefore more particulate material was included in the flooring material when it was manufactured in anticipation of this problem. Since in the present invention this problem with low retention has been overcome, a lower concentration of polymeric particles may be included. Thus polymeric particles are included at a concentration of preferably from 10, more preferably from 50, preferably to 300, more preferably 150 g/m².

The flooring material according to the invention optionally further comprises one or more additional particulate materials such as a glass bead or flake, crushed glass, white aluminium oxide, clear quartz, an alumina silicate, micaceous material (such as Mica), nylon powder, a nylon bead, a rubber particle, rubber powder, a polymeric powder, a polymeric bead, a ceramic material, a synthetic crystal, a fibre (such as a fibre of Nylon), titanium dioxide, wax and/or liquid rubber.

Optionally the flooring material further includes an additive commonly used in the art such as a UV stabiliser, a biocide, and/or a flow aid such as fumed silica.

The first layer of plastics material is optionally either a coating layer or a base layer. Where the first layer is a coating layer, the flooring material additionally comprises at least one base layer; preferably the polymeric particles penetrate the first layer to the base layer.

Where the first layer of plastics material is a coating layer, it preferably includes a thermoplastic or a cross-linkable polymer or copolymer. For the cross-linkable polymer or copolymer, cross-linking may be effected by condensation or by a free radical route such as using UV radiation. It will be understood that a cross-linkable polymer used in the invention is generally a thermoset polymer. Examples of suitable polymers or copolymers include PvdF, a polyester, polyurethane, or acrylic polymer or copolymer, an epoxy resin, and/or an olefin/modified olefin copolymer. More preferably the coating layer includes an acrylic polymer. Most preferably the coating layer includes a mixture of an acrylic polymer with PvdF. Preferably the coating layer is substantially free from a thermosetting polymer or co-polymer. This is because thermosetting polymers or copolymers are not generally sufficiently fast curing or flexible enough to be useful in the coating layer of the flooring material.

A base layer for use in the flooring material according to the invention preferably comprises a plastics material such as PVC, a polyurethane, an epoxy resin, a plasticised acrylic, and/or a polyester. More preferably, the plastics material is a PVC plastisol or a plasticised acrylic material.

The flooring material preferably includes a reinforcing support; the support is preferably a glass fibre reinforced non-woven support.

The flooring material may optionally comprise one or more additional base layers; preferably up to three layers are envisaged.

The flooring material optionally includes a design layer. A design layer comprises a layer of ink or a printed film layer (the film is preferably formed from a plastics material such as PVC) which gives the flooring material an attractive appearance. In order that the design layer is visible, the first layer is substantially transparent when the flooring material includes a design layer. In a preferred embodiment, one or more substantially transparent base layers are optionally provided between the first layer and the design layer.

The flooring material may optionally further contain a decorative additive such as a quartz chip, a pigment and/or a pigmented PVC chip. Preferably the flooring material is embossed.

According to the invention there is also provided a method of manufacturing a slip resistant flooring material which method comprises the steps of:
applying a first layer of plastics material;
applying a particulate layer of polymeric particles to an upper surface of the first layer; and
curing the plastics material such that it forms a continuous film and such that the polymeric particles bond to the first layer;

wherein the-polymeric particles provide a slip-resistant effect.

The curing step is preferably performed such that there are substantially no crevices between the polymeric particles and the first layer of plastics material.

The method of the invention preferably comprises a step of applying at least one base layer. In such a method, the first layer is a coating layer which is applied to an upper surface of the base layer.

The method of the invention preferably comprises a step of applying a design layer wherein the first layer of plastics material is substantially clear and is applied to an upper surface of the design layer. More preferably the method of the invention comprises steps of:
applying a base layer;
applying a design layer on an upper surface of the base layer; and
applying a first layer on an upper surface of the design layer.

Preferably this method comprises a step of applying one or more substantially transparent base layers on the upper surface of the design layer.

The invention will now be described with reference to the following Figures of the accompanying drawings which are not intended to limit the scope of the invention in which:

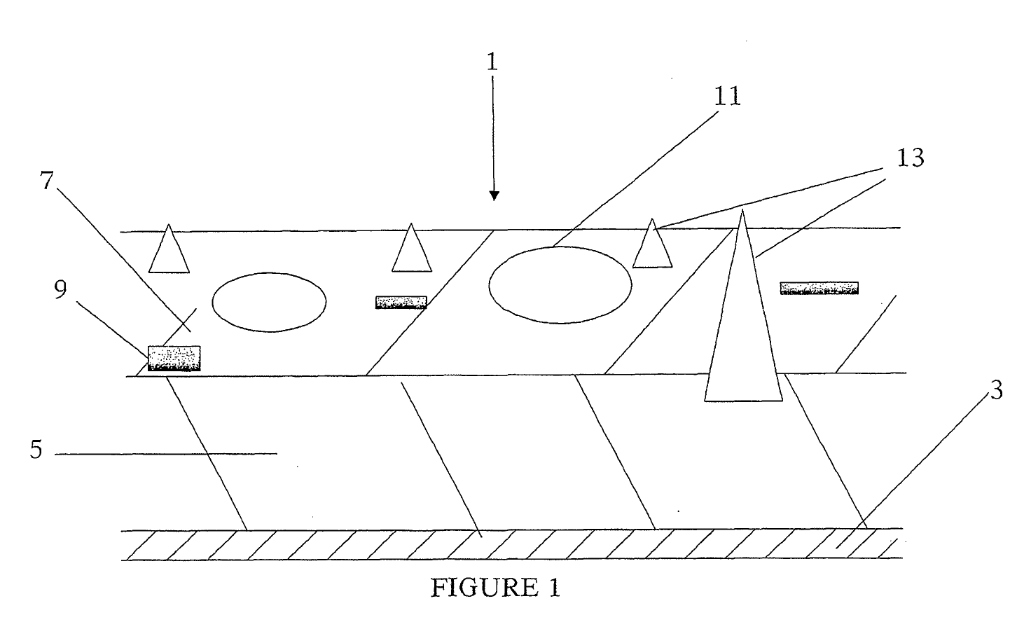

FIG. 1 shows a schematic cross-section of a first embodiment of a flooring material according to the invention;

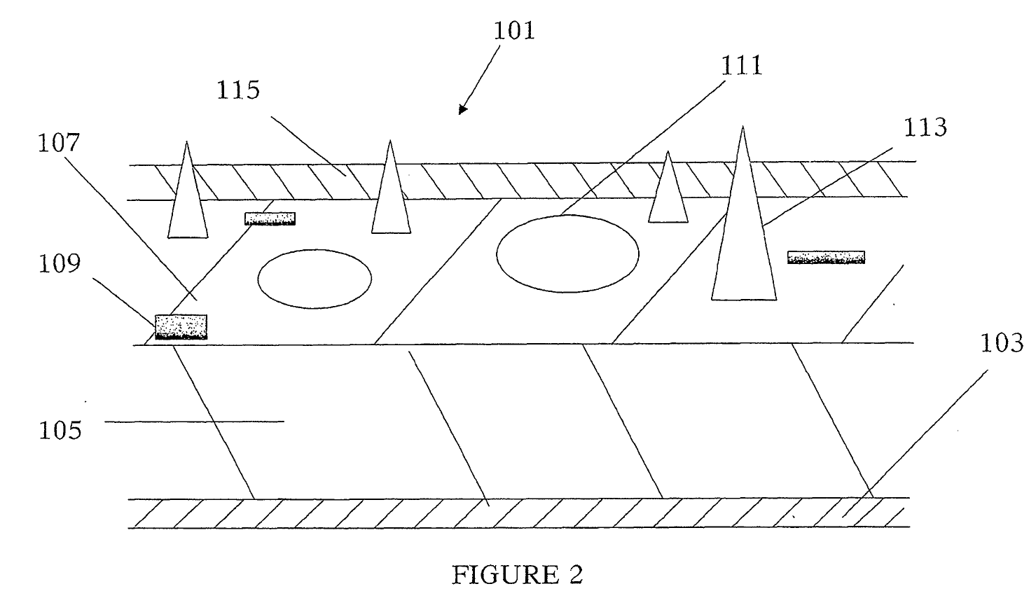

FIG. 2 shows a schematic cross-section of a second embodiment of a flooring material according to the invention; and

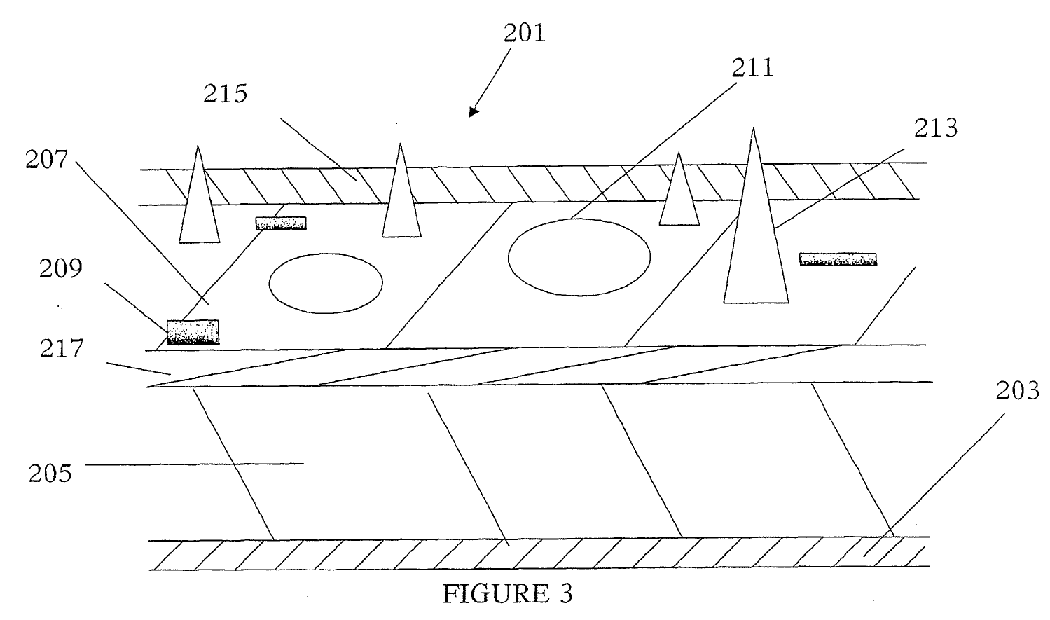

FIG. 3 shows a schematic cross-section of a third embodiment of a flooring material according to the invention;

The first embodiment of a flooring material 1 illustrated in FIG. 1 includes a substrate 3 which is a cellulose/polyester support (Dexter 555:030) reinforced with a Kirson “5×5” 32 tex glass crennette. The substrate 3 is approximately 0.15 mm in thickness. On top of the substrate 3 there is a PVC plastisol undercoat 5 which is approximately 1 mm thick. On top of the undercoat 5 there is a layer 7 of PVC plastisol which is about 0.8 mm thick. Embedded within the layer 7 there are glass beads 11 and coloured PVC chips 9. Embedded in and proud of the layer 7 and penetrating to undercoat 5 are polymeric grits 13.

As an alternative to the embodiment depicted in FIG. 1, the undercoat 5 and layer 7 may be provided as a single layer, the glass beads 11 and/or the coloured PVC chips 9 may be omitted, and/or further particulate material may be included such as aluminium oxide grits.

The second embodiment of a flooring material 101 illustrated in FIG. 2 includes a substrate 103, undercoat 105 and a layer 107 of PVC plastisol as in the first embodiment. Embedded within the layer 107 there are glass beads 111 and coloured PVC chips 109. On top of the PVC plastisol layer 107, there is a barrier layer 115 of PVDF. Embedded in and proud of the barrier layer 115 and penetrating to the layer 107 are polymeric grits 113.

As an alternative to the embodiment depicted in FIG. 2, the undercoat 105 and layer 107 may be provided as a single layer, the glass beads 111 and/or the coloured PVC chips 109 may be omitted, further particulate material may be included such as aluminium oxide grits, and/or the barrier layer may be formed from a different material from PVDF such as another thermoplastic polymer or a cross-linkable polymer.

The third embodiment of a flooring material 201 illustrated in FIG. 3 includes a substrate 203, a PVC plastisol undercoat 205. On top of the undercoat layer 205, there is a design layer 217 which comprises a layer of water-based ink applied by gravure printing. On top of the design layer is a layer 207 of PVC plastisol. Embedded within the layer 207 there are glass beads 211 and coloured PVC chips 209. On top of the PVC plastisol layer 207, there is a barrier layer 215 of PVDF. Embedded in and proud of the barrier layer 215 and penetrating to the layer 207 are polymeric grits 213.

As an alternative to the embodiment depicted in FIG. 3, the undercoat 205 and layer 207 may be provided as a single layer, the glass beads 211 and/or the coloured PVC chips 209 may be omitted, further particulate material may be included such as aluminium oxide grits, and/or the barrier layer may be formed from a different material from PVDF such as another thermoplastic polymer or a cross-linkable polymer.

The invention is further illustrated with reference to the following examples which are not intended to limit the scope of the invention claimed.

### PREPARATIVE EXAMPLE 1

Plastisols having the formulations given in Table 1 were produced as described below.

TABLE 1
Plastisol Formulations

| | A. | B. |
|---|---|---|
| | Weight/kg | Weight/kg |
| Solvic 380NS | 15 | 20 |
| Solvic 266SF | 5 | — |
| Jayflex DIDP | 6.5 | 6.5 |
| Microdol H155 | — | 5 |
| Viscobyk 4040 | — | 0.4 |
| BZ505 | 0.3 | 0.4 |
| ABF2 ESBO | — | 0.2 |
| Blue BLP pigment | — | 0.02 |

Wherein Solvic 380NS and Solvic 266SF are PVC polymers manufactured by Solvay; Jayflex DIDP is a di-isodecyl phthalate plasticiser manufactured by Exxon; Microdol H155 is a calcium magnesium carbonate manufactured by Omya; Viscobyk 4040 is a blend of aliphatic hydrocarbons with a neutral wetting and dispersing component manufactured by BYK Chemie; BZ505 is a liquid barium zinc preparation containing organic barium compounds and phosphite manufactured by Witco; ABF2 ESBO is a solution of 10,10′ oxybisphenoxyarsine in epoxidised soya bean oil manufactured by Akcros Chemicals; Blue BLP pigment is a phthalocyanine blue pigment manufactured by Ciba Pigments.

In each case, the ingredients were weighed in to a 50 litre steel vessel and mixed by a Zanelli MLV/50 mixer using a trifoil shaft at 100 rpm for 4 minutes and a dissolver shaft at 1800 rpm for 2 minutes. Aluminium 10 oxide particles (from Washington Mills) size F40 (FEPA Standard 42-GB-1984 measurement) were weighed into plastisol B (10% w/w) and mixed.

In the case of plastisol A, clear reinforced glass beads (from Boud Marketing) size F36 (FEPA Standard 42-GB-1984 measurement) were weighed (10% w/w) and admixed.

### PREPARATIVE EXAMPLE 2

A thermoplastic powder coating C having the formulation shown in Table 2 was produced as described below.

TABLE 2
Powder Coating Formulation C

| | Weight/kg |
|---|---|
| Kynar 500PC | 10 |
| Acryloid B-44 | 4.8 |
| Kynar ADS | 1.1 |
| Irganox 1010 | 0.05 |

Kynar 500PC is a poly(vinylidene)fluoride polymer manufactured by Elf Atochem. Kynar ADS is a low melting point fluorine-based terpolymer also manufactured by Elf Atochem. Acryloid B-44 is a methyl methacrylate/ethyl acrylate copolymer manufactured by Rohm & Haas. Irganox 1010 is an anti-oxidant manufactured by Ciba Geigy.

The ingredients were weighed and blended by being tumbled together. The blend was extruded in a Werner and Pfleiderer extruder (Model ZSK-70) with the screw rotation set at 313 rpm, the barrel set at 200° C. and the feed zone set at 30° C. The extrudate was collected in large containers (of dimensions: 380 mm×305 mm×75 mm) and allowed to cool slowly at ambient temperature for 8 hours. The resulting blocks were broken into smaller pieces by mechanical attrition. The material was then ground in an Alpine Pin disc mill, using a single pass and no intermediate sieving screen. The temperature of the material prior to its introduction into the mill was −100° C.; the mill was maintained at −35° C. during grinding. 99% of the resulting powder was of a size of below 90 microns and the average powder size was 37 μm.

### EXAMPLE 3

Plastisol A was spread coated onto a substrate to a thickness of 2 mm by knife over roller. The substrate was a 2 m width cellulose/polyester support (Dexter 555:030) reinforced with a Kirson ‘5×5’ 68 tex glass crennette, moving at a rate of 5 m/minute. Particles of Aluminium Silicate of a size of 1.2-1.8 mm were then scattered onto the surface of the plastisol at a rate of 300 gm⁻². The system was then passed in to a convection oven where it was exposed to 195° C. for 2.5 minutes before being embossed, cooled and wound up for subsequent trimming to size.

### EXAMPLE 4

In this Example, the preparation of a flooring material as depicted in FIG. 1 is described.

Plastisol B was spread coated onto a substrate to a thickness of 1 mm by knife over roller. The substrate was a 2 m width cellulose/polyester support (Dexter 555:030) reinforced with a Kirson ‘5×5’ 32 tex glass crennette moving at a rate of 7 metres/minute. The system was then passed into a convection oven where it was exposed to 160° C. for 2 minutes. The system was then passed through a series of cooling rollers before it was over coated with plastisol A to a total thickness of 2mm by knife over bed.

Polymeric particles of modified PMMA were prepared from a sheet of Plexiglas from Atofina by grinding the sheet in an Alpine Pin disc mill, using a single pass and no intermediate sieving screen. The mill was maintained at −35° C. during grinding. 99% of the resulting particles were of a size of below 650 microns and the average particle size was 450 μm. The polymeric particles of modified PMMA were then scattered onto the surface of the plastisol at a rate of 300 g/m². The system was then passed in to a convection oven where it was exposed to 190° C. for 2.5 minutes before being embossed, cooled and wound up for subsequent trimming to size. The polymeric particles preferably have a size of from 100, preferably from 300, more preferably from 400, preferably to 1000 μm, more preferably to 800 μm, most preferably to 600 μm, e.g. from 100 to 1000 μm, or from 300 to 600 μm or from 400 to 800 μm. Preferably the particle size distribution of the polymeric particles is such that there are substantially no fines. More preferably, the particle size distribution is such that there are no particles having a size of less than 100 μm, preferably of less than 300 μm, more preferably of less than 400 μm. The problem with a flooring material according to the invention which is formed from polymeric particles which include fines is that the flooring material is rough and abrasive, like sandpaper. Whilst it is important for the flooring material according to the invention to be non-slip, it should not be so abrasive that it becomes difficult to handle.

Comparative visual tests showed that the appearance of the flooring material prepared in Examples 2 and 3 was not impaired by the addition of the anti-slip material.

The slip resistance of the flooring material produced by Examples 3 and 4 was measured by using a TRRL pendulum and a 4S standard rubber. It was surprisingly found that their slip resistance was approximately the same and had a value recommended by the UK Slip Resistance Group guidelines as giving low potential to slip (TRRL>36).

### EXAMPLE 5

In this Example, the preparation of a flooring material as depicted in FIG. 2, where undercoat 105 and layer 107 are provided by a single layer, is described.

Plastisol A was spread coated on a substrate to a thickness of 2 mm by knife over roller. The substrate was a 2 m width cellulose/polyester support (Dexter 555:030) reinforced with a Kirson ‘3×2’ 32 tex glass crennette moving at a rate of 3 metre/minute. Particles of coloured quartz of a size of 1.2-1.8 mm were then scattered on to the surface of the plastisol at a rate of 500 g/m². The coated web was then passed under a 50 kW medium wave infra red heater (width 2.5 m; length 1 m). The heater was positioned at a height of 10cm above the web. The power output of the heater was adjusted so that the surface of the plastisol as it exited the infra red zone was fully solidified (‘gelled’) to the touch.

An acrylic based clear coating powder C, was then applied to the surface at a rate of 80±30 g/m² using a scatter powder coating application system. Polymeric particles of modified PMMA obtained as described above were then scattered on to the surface at the rate of 100 g/m². The system was then passed in to a convection oven where it was exposed to 190° C. for 2 minutes before being embossed, cooled and wound up for subsequent trimming to size.

The flooring material thus obtained was placed in a busy corridor. After 2 weeks, it was removed and cleaned using conventional methods. It was found that substantially all of the dirt could be removed. To compare, a prior art flooring material was prepared in the same manner, having silicon carbide particles instead of polymeric particles of modified PMMA. The prior art flooring material was subjected to the same test and it was found that more dirt remained on the flooring material after cleaning.

### EXAMPLE 6

In this Example, the preparation of a flooring material as depicted in FIG. 3 is described.

Plastisol B was spread coated onto a substrate to a thickness of 1 mm by knife over roller. The substrate was a 2 m width cellulose/polyester support (Dexter 555:030) reinforced with a Kirson ‘5×5’ 32 tex glass crennette moving at a rate of 7 metres/minute. The system was then passed over a gel drum to partially cure and flatten the layer of plastisol.

A layer of water-based ink was then applied to the system by gravure printing to give the system an attractive patterned appearance.

Plastisol A was spread coated on the system to a thickness of 2 mm by knife over roller. The coated web was then passed under a 50 kW medium wave infra red heater (width 2.5 m; length 1 m). The heater was positioned at a height of 10 cm above the web. The power output of the heater was adjusted so that the surface of the plastisol as it exited the infra red zone was fully solidified (‘gelled’) to the touch.

An acrylic based clear coating powder C, was then applied to the surface at a rate of 80±30 g/m² using a scatter powder coating application system. Polymeric particles of modified PMMA obtained as described above were then scattered on to the surface at the rate of 100 g/m². The system was then passed in to a convection oven where it was exposed to 190° C. for 2 minutes before being embossed, cooled and wound up for subsequent trimming to size.

### EXAMPLE 6

In this Example, the preparation of a flooring material as depicted in FIG. 3 is described.

Plastisol B was spread coated onto a substrate to a thickness of 1 mm by knife over roller. The substrate was a 2 m width cellulose/polyester support (Dexter 555:030) reinforced with a Kirson ‘5×5’ 32 tex glass crennette moving at a rate of 7 metres/minute. The system was then passed over a gel drum to partially cure and flatten the layer of plastisol.

A printed layer of PVC film was then laminated to the system using heat and pressure to give the system an attractive patterned appearance. The temperature of the system comprising the coated support was 140° C. and the temperature of the printed film was 80° C. The printed film was applied to the coated support at a pressure of 5 bar.

Plastisol A was spread coated on the system to a thickness of 2 mm by knife over roller. The coated web was then passed under a 50 kW medium wave infra red beater (width 2.5 m; length 1 in). The heater was positioned at a height of 10 cm above the web. The power output of the heater was adjusted so that the surface of the plastisol as it exited the infra red zone was fully solidified (‘gelled’) to the touch.

An acrylic based clear coating powder C, was then applied to the surface at a rate of 80±30 g/m² using a scatter powder coating application system. Polymeric particles of modified PMMA obtained as described above were then scattered on to the surface at the rate of 100 g/m². The system was then passed in to a convection oven where it was exposed to 190° C. for 2 minutes before being embossed, cooled and wound up for subsequent trimming to size.

1. A slip-resistant plastics flooring material having a first layer of plastics material which first layer has on its upper surface a particulate layer of one or more
polymeric particles, which polymeric particles provide a slip-resistant effect and are bonded to the first layer of plastics material.

2. A flooring material as defined in claim 1 wherein there are substantially no crevices between the polymeric particles and the first layer of plastics material.

3. A flooring material as defined in claim 1 wherein the plastics material used to form the first layer of plastics material is substantially free from polymeric particles which provide a slip-resistant effect.

4. A flooring material as defined in claim 1 wherein the polymeric particles are formed from an optionally modified polymer such as an acrylic and/or polyarcrylate (e.g. polymethylmethacrylate (PMMA) and/or polybutylmethacrylate (PBMA)), a polycarbonate, a nylon, a polyester, a polyolefin, a polyacetal, an ionomer, a polyvinylidene fluoride (PVDF), an acrylonitrile butadiene styrene (ABS), polyaryletherketone (PEEK), and/or polyethersulphone (PES.

5. A flooring material as defined in claim 1 which comprises a base layer wherein the first layer is a coating layer.

6. A flooring material as defined in claim 5 wherein the coating layer includes a thermoplastic or a cross-linkable polymer or copolymer.

7. A flooring material as defined in claim 5 wherein the coating layer includes a PVDF, a polyester, polyurethane, or acrylic polymer or copolymer, an epoxy resin, and/or an olefin/modified olefin copolymer.

8. A flooring material as defined in claim 5 wherein the coating layer if free from a plasticizer.

9. A flooring material as defined in claim 1 wherein the first layer is a base layer.

10. A flooring material as defined in claim 5 wherein the base layer includes a plastics material such as PVC, a polyurethane, an epoxy resin, a plasticised acrylic, and/or a polyester.

11. A flooring material as defined in claim 5 which comprises one or more additional base layers.

12. A flooring material as defined claim 1 wherein the first layer of plastics material is a layer of substantially clear plastics material.

13. A flooring material as defined in claim 12 wherein the first layer is substantially transparent.

14. A flooring material as defined in claim 13 which includes a design layer;

15. A flooring material as defined in claim 14 wherein one or more substantially transparent base layers are optionally provided between the first layer and the design layer.

16. A flooring material as defined in claim 1 wherein the first layer of plastics material is a layer of coloured plastics material.

17. A flooring material as defined in claim 1 wherein the colour and/or appearance of the polymeric particles is matched to the colour and/or appearance of the plastics materials of the first layer.

18. A method of manufacturing a slip resistant flooring material which method comprises the steps of:
applying a first layer of plastics material;
applying a particulate layer of polymeric particles to an upper surface of the first layer;
curing the plastics material such that it forms a continuous film and such that the polymeric particles bond to the first layer;
wherein the polymeric particles provide a slip-resistant effect.

19. A method as defined in claim 18 wherein the curing step is performed such that there are substantially no crevices between the polymeric particles and the first layer of plastics material.

20. A method as defined in claim 18 wherein the plastics material used to form the first layer of plastics material is substantially free from polymeric particles which provide a slip-resistant effect.

21. A method as defined in claim 18 wherein the polymeric particles are formed from an optionally modified polymer such as an acrylic and/or polyarcrylate (e.g. polymethylmethacrylate (PMMA) and/or polybutylmethacrylate (PBMA)), a polycarbonate, a nylon, a polyester, a polyolefin, a polyacetal, an ionomer, a polyvinylidene fluoride (PVDF), an acrylonitrile butadiene styrene (ABS), polyaryletherketone (PEEK), and/or polyethersulphone (PES.

22. A method as defined in claim 18 which comprises the step of applying at least one base layer wherein the first layer is a coating layer which is applied to an upper surface of the base layer.

23. A method as defined in claim 22 wherein the coating layer includes a thermoplastic or a cross-linkable polymer or copolymer.

24. A method as defined in claim 22 wherein the coating layer includes a PVDF, a polyester, polyurethane or acrylic polymer or copolymer, an epoxy resin, and/or an olefin/modified olefin copolymer.

25. A flooring material as defined in claim 22 wherein the coating layer is free from a plasticizer.

26. A method as defined in claim 18 wherein the first layer includes a plastics material such as PVC, a polyurethane, an epoxy resin, a plasticized acrylic, and/or a polyester.

27. A method as defined in claim 18 wherein the first layer of plastics material is a layer of substantially clear plastics material.

28. A method as defined in claim 27 which comprises a step of applying a design layer and wherein the first layer of substantially clear plastics material is applied to an upper surface of the design layer.

29. A method as defined in claim 28 which comprises a step of applying one or more substantially transparent base layers on the upper surface of the design layer.

30. A method as defined in claim 18 wherein the first layer of plastics material is a layer of coloured plastics material.

31. A method as defined in claim 18 wherein the colour and/or appearance of the polymeric particles is matched to the colour and/or appearance of the plastics material of the first layer.

32. A flooring material as defined in claim 14 wherein the flooring material comprises a first layer provided on an upper surface of a design layer which is provided in an upper surface of a base layer.

33. A method as defined in claim 28 wherein the method comprises steps of:
applying a base layer;
applying a design layer on an upper surface of the base layer; and
applying a first layer on an upper surface of the design layer.
